(19) United States
(12) Patent Application Publication
(10) Pub. No.: US 2026/0340389 A1
(43) Pub. Date: Oct. 29, 2026

(54) MANAGING GENERATIVE ARTIFICIAL INTELLIGENCE (AI) SESSIONS

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,723

(22) Filed: Apr. 28, 2025

(51) Int. Cl. G06N 3/082; G06F 40/40; G06N 3/0475

(52) U.S. Cl. CPC G06N 3/082; G06F 40/40; G06N 3/0475

(57) ABSTRACT

Methods and systems for providing computer-implemented services using generative artificial intelligence (AI) models are disclosed. To do so, a request to generate a second generative AI session based on a first generative AI session while continuing the first generative AI session may be obtained. The first generative AI session may include prompts provided by a downstream consumer and outputs generated by a first instance of a generative AI model based on the prompts. A copy of the first generative AI session may be reverted to an earlier point in the first generative AI session to obtain the second generative AI session and a second instance of the generative AI model. A prompt may be obtained for the second generative AI session and an output may be obtained using the second instance of the generative AI model and the prompt. Computer-implemented services may be provided using at least the output.

### FIELD

Embodiments disclosed herein relate generally to providing computer-implemented services using generative artificial intelligence (AI) models. More particularly, embodiments disclosed herein relate to managing generative AI sessions.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2D show flow diagrams illustrating data flows in accordance with an embodiment.

FIGS. 2E-2H show an example graphical user interface (GUI) and example generative AI sessions in accordance with an embodiment.

FIG. 3 shows a flow diagram illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with prompts. The outputs may be used, at least in part, to provide the computer-implemented services. For example, the outputs may be provided to a downstream consumer and the downstream consumer may use the outputs to make decisions.

The outputs may be provided to downstream consumers as part of generative AI sessions (e.g., chat sessions) with the downstream consumers. A generative AI session may include any exchange of prompts from a first entity (e.g., a downstream consumer) and outputs from a second entity (e.g., a generative AI model). For example, a chat session may be initiated by a downstream consumer (e.g., a client, a customer) via a graphical user interface (GUI). The customer may enter a prompt, which may be displayed in a chat window of the GUI. The prompt may be used as ingest for a generative AI model and the output generated by the generative AI model may be added to the chat window as a response from a chat agent (e.g., a virtual assistant). The downstream consumer may enter additional prompts during the chat session and all prompts and outputs may be recorded on the chat window during the chat session.

However, generative AI models may generate new outputs based on all components of the chat history (e.g., all prompts and outputs during the chat session). Therefore, if a downstream consumer mistakenly enters some information as a prompt or decides that a previously entered prompt is no longer desired to be used as part of the chat session (e.g., due to eliciting an unwanted response), the downstream consumer may have to begin a new chat session and/or may receive outputs during the chat session that do not meet needs of the downstream consumer (e.g., may be inaccurate, may be irrelevant). In addition, the user may be interested in learning how the outputs would change if different prompts were provided.

To improve a user's (e.g., a downstream consumer's) experience and increase a likelihood of providing outputs that meet expectations of the downstream consumer, a request may be obtained from the downstream consumer to generate a second generative AI session based on a portion of a first generative AI session while continuing the first generative AI session. The first generative AI session may include prompts provided by the downstream consumer and outputs generated by a first instance of a generative AI model based on the prompts.

A copy of the first generative AI session may be reverted, based on the request, to an earlier point in the first generative AI session to obtain the second generative AI session and a second instance of the generative AI model. By doing so, the first generative AI session (e.g., that uses the first instance of the generative AI model) and the second generative AI session (e.g., that uses the second instance of the generative AI model) may be simultaneously active.

At a time of generation of the second generative AI session, the generative AI session may begin at a start of the first generative AI session and may end at the earlier point in the first generative AI session as indicated by the request. By doing so, the downstream consumer may be able to continue the second generative AI session from the earlier point by providing a new prompt as part of the second generative AI session. The new prompt may be used by the second instance of the generative AI model to generate a new output as part of the second generative AI session.

Thus, embodiments disclosed herein may provide an improved method for providing computer-implemented services using generative AI models. By branching the generative AI session (e.g., generating a second generative AI session by reverting a copy of the first generative AI session to an earlier point), the downstream consumer may provide different prompts than those provided during the first generative AI session. Therefore, the downstream consumer may learn how the interaction may change if different prompts are provided at a point in the generative AI session. By doing so, computer-implemented services based on the first and second generative AI sessions may be more likely to meet needs of the downstream consumer.

In an embodiment, a method for providing computer-implemented services using generative AI models is provided. The method may include: obtaining, from a downstream consumer, a request to generate a second generative AI session based on a portion of a first generative AI session while continuing the first generative AI session, the first generative AI session comprising prompts provided by the downstream consumer and outputs generated by a first instance of a generative AI model of the generative AI models based on the prompts; reverting, based on the request, a copy of the first generative AI session to an earlier point in the first generative AI session to obtain the second generative AI session and a second instance of the generative AI model; obtaining a first prompt from the downstream consumer for the second generative AI session, the first prompt not being part of the first generative AI session; obtaining, using the second instance of the generative AI model and the first prompt, a first output; and providing computer-implemented services to the downstream consumer using at least the first output.

The method may also include: obtaining, from the downstream consumer, a second prompt for the first generative AI session; and obtaining, using the first instance of the generative AI model and the second prompt, a second output, wherein the computer-implemented services are also provided using the second output.

The second generative AI session and the second instance of the generative AI model may not operate on the second prompt.

The second generative AI session may begin at a start of the first generative AI session and may end at the earlier point in the first generative AI session when the copy of the first generative AI session is reverted to the earlier point in the first generative AI session.

The first generative AI session and the second generative AI session may be displayed to the downstream consumer via at least one graphical user interface (GUI).

Reverting the copy of the first generative AI session to the earlier point in the first generative AI session may include: obtaining a snapshot of the first instance of the generative AI model, the snapshot being generated at the earlier point in the first generative AI session; and using the snapshot as the second instance of the generative AI model.

The snapshot may include: prompts provided by the downstream consumer prior to the earlier point in the first generative AI session; outputs generated by the first instance of the generative AI model prior to the earlier point in the first generative AI session; and a memory of the first generative AI session based on the prompts and the outputs, the memory comprising attention values assigned to portions of the prompts and the outputs.

The method may also include: prior to obtaining the request: generating the snapshot at the earlier point in the first generative AI session; and storing the snapshot in a snapshot database.

Reverting the copy of the first generative AI session to the earlier point in the first generative AI session may include: obtaining information elements corresponding to information content that is to be removed from an internal state of the first instance of the generative AI model; obtaining attention strengths for the first instance of the generative AI model corresponding to each of the information elements; generating, using the attention strengths, un-inferencing weights for the information elements; and performing, using the un-inferencing weights, an un-inferencing process for the first instance of the generative AI model to obtain the second instance of the generative AI model.

The second instance of the generative AI model may be less impacted by the information elements than the first instance of the generative AI model.

The attention strengths may be based on frequencies of occurrence of the information elements in a generative AI session history for the first generative AI session.

Performing the un-inferencing process may include at least one action selected from a list of actions consisting of: negating, using the un-inferencing weights, embeddings corresponding to the information elements to obtain the second instance of the generative AI model; adding, based on the request and using the un-inferencing weights, a negation layer to an input layer of the first instance of the generative AI model to obtain the second instance of the generative AI model; adding, based on the request and using the un-inferencing weights, the negation layer prior to an attention module of the first instance of the generative AI model to obtain the second instance of the generative AI model; and adding, based on the request and using the un-inferencing weights, the negation layer to a hidden layer of the attention module to obtain the second instance of the generative AI model.

The negation layer may multiply each information element by a corresponding un-inferencing weight of the un-inferencing weights to obtain an un-inferenced value for the information element, the un-inferenced value having less impact on future outputs generated by the second instance of the generative AI model than the information element.

The generative AI model may be a large language model (LLM).

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

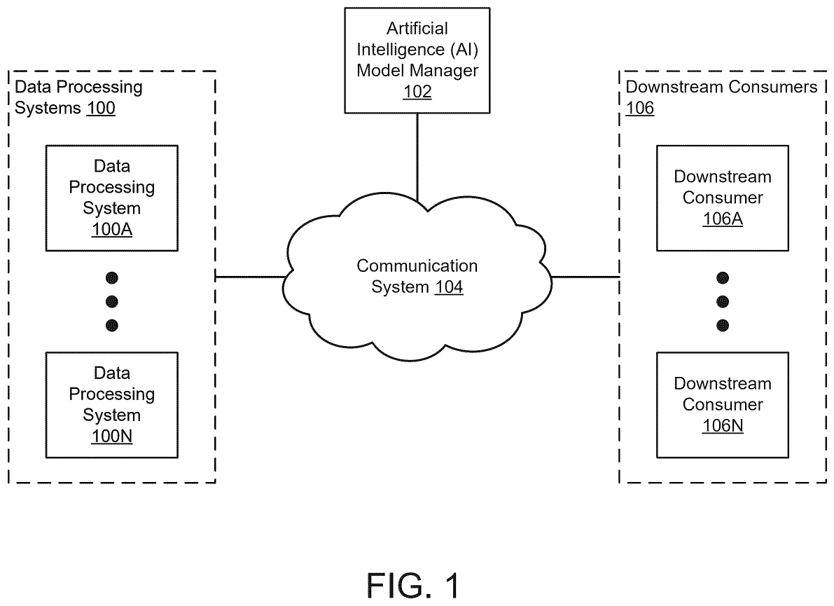

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

The outputs may be provided to downstream consumers 106 as part of generative AI sessions (e.g., chat sessions) with downstream consumers 106. A chat session may include, for example, a real-time interaction between two entities (e.g., a downstream consumer and an AI agent) during which information is exchanged. The information may include prompts provided by the downstream consumer and outputs generated by a generative AI model. The prompts and the outputs may include any type of data modality (e.g., images, audio, video, text).

A chat session may be accessed by a downstream consumer (e.g., 106A) via a graphical user interface (GUI) used as part of, for example, a customer support service, a data analysis service, a content creation service, and/or other services. Downstream consumer 106A may provide a prompt and the AI agent may provide an output that is responsive to the prompt. The AI agent may include a software program that manages, at least in part, operation of the generative AI model and that serves as a proxy for the generative AI model in a simulated conversation with the downstream consumer during the chat session. The generative AI model may use all previous prompts and all previously generated outputs to generate each additional output as part of the chat session.

However, downstream consumer 106A may provide information content via a prompt that is: (i) erroneous, (ii) irrelevant, and/or (iii) otherwise not desired to be used during a remainder of the chat session. In addition, a prompt may elicit an unwanted response (e.g., a generative AI model output that does not meet expectations of downstream consumer 106A). As the information content may impact the remainder of the chat session, outputs generated by the generative AI model during the chat session may no longer meet expectations of downstream consumer 106A (e.g., may include inaccurate and/or irrelevant information). In addition, downstream consumer 106A may be interested to know how the generative AI session may change if different prompts were entered at a point in the generative AI session.

In general, embodiments disclosed herein may provide methods, systems, and/or devices for branching a first generative AI session so that a second generative AI session and the first generative AI session may be simultaneously active (e.g., downstream consumer 106A may provide prompts to both the first and second generative AI sessions separately).

The second generative AI session may be based on a portion of the first generative AI session (e.g., an earlier point in the first generative AI session may be identified and used as the point of branching of the first generative AI session into two generative AI sessions (e.g., the first and second generative AI session). By doing so, downstream consumer 106A may choose to provide different prompts as part of the second generative AI session and, consequently, may see how the interactions (e.g., the chat sessions) may have changed based on the different prompts.

To branch the first generative AI session and obtain the second generative AI session, a copy of the first generative AI session may be reverted to the earlier point in the first generative AI session. Downstream consumer 106A may, for example, select the earlier point via interaction with one or more graphical user interfaces (GUIs).

Reverting the copy of the first generative AI session to the earlier point may include obtaining a second instance of the generative AI model. The second instance of the generative AI model may be used to generate outputs as part of the second generative AI session and the first instance of the generative AI model may be used to continue the first generative AI session.

Reverting the copy of the first generative AI session to the earlier point may include: (i) obtaining a snapshot of the first instance of the generative AI model (e.g., generated at the earlier point in time) and using the snapshot as the second instance of the generative AI model, (ii) performing an un-inferencing process using the first generative AI session to generate the second instance of the generative AI model, and/or (iii) other methods.

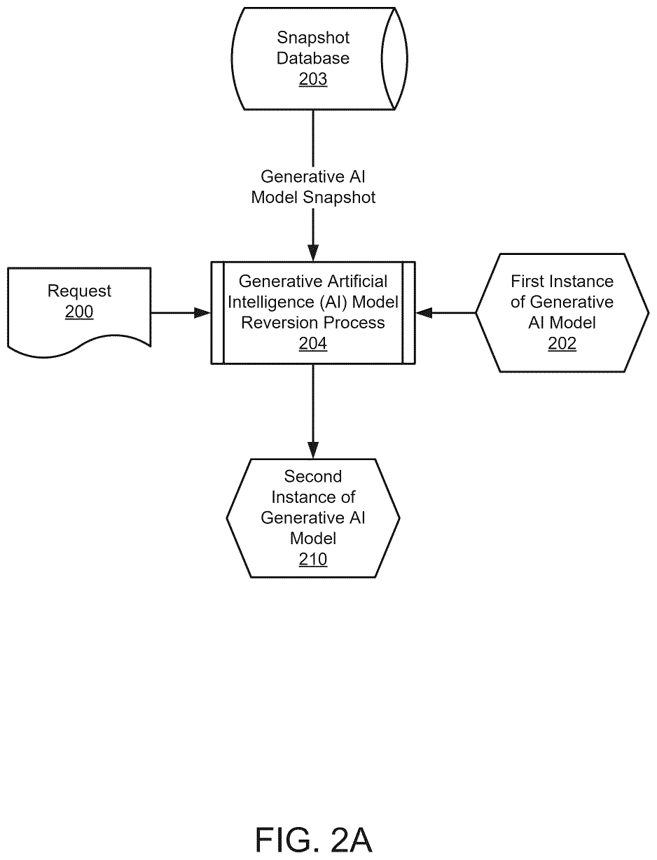

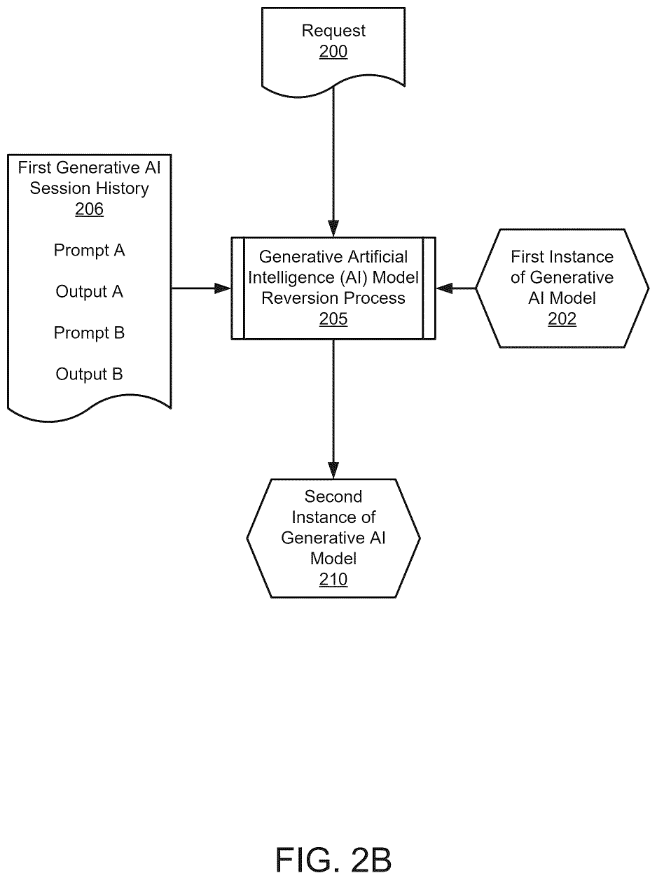

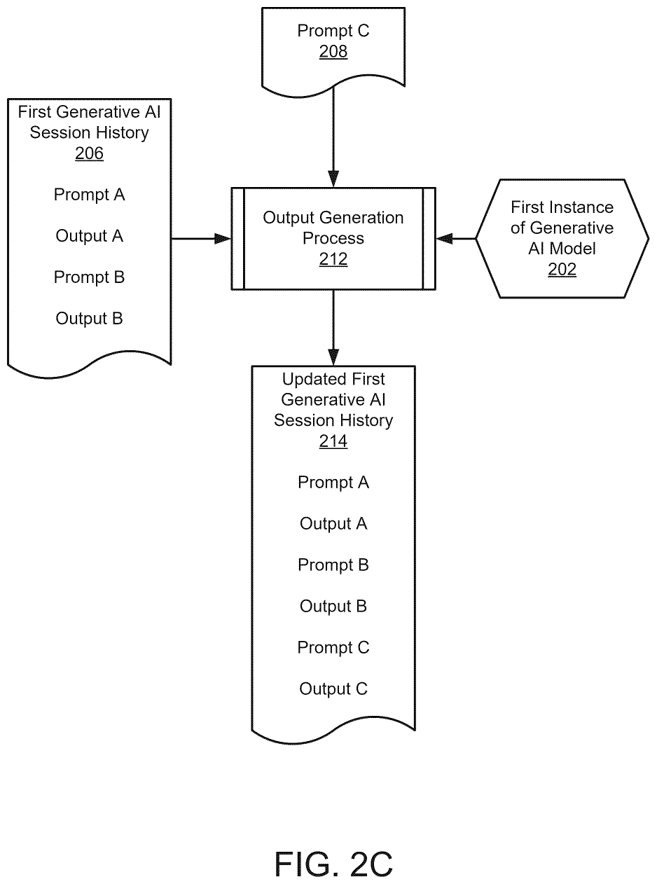

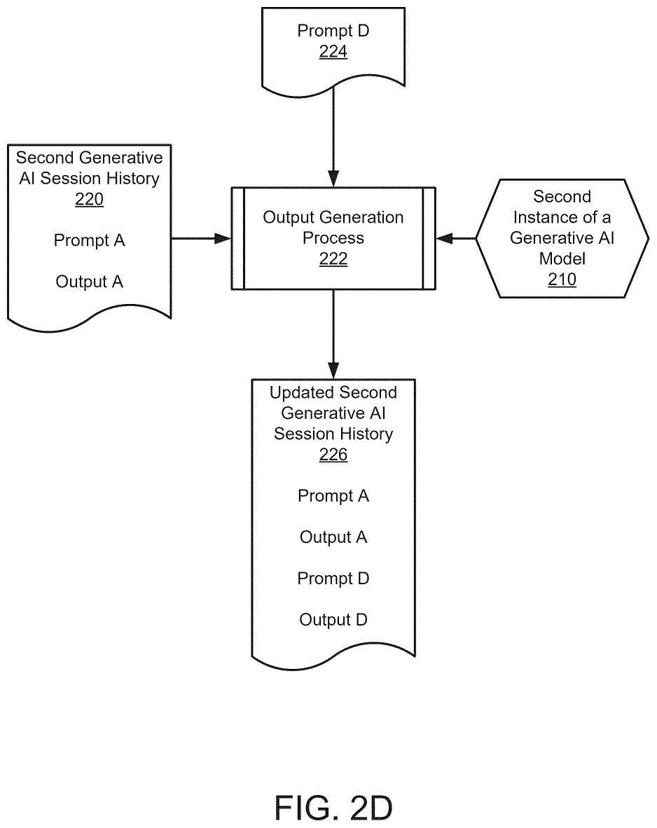

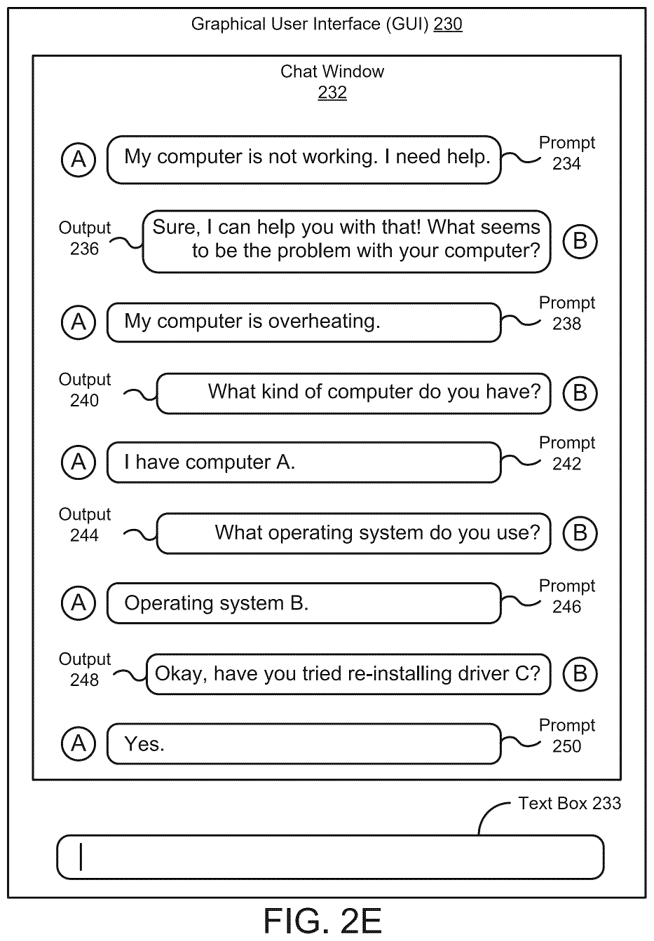

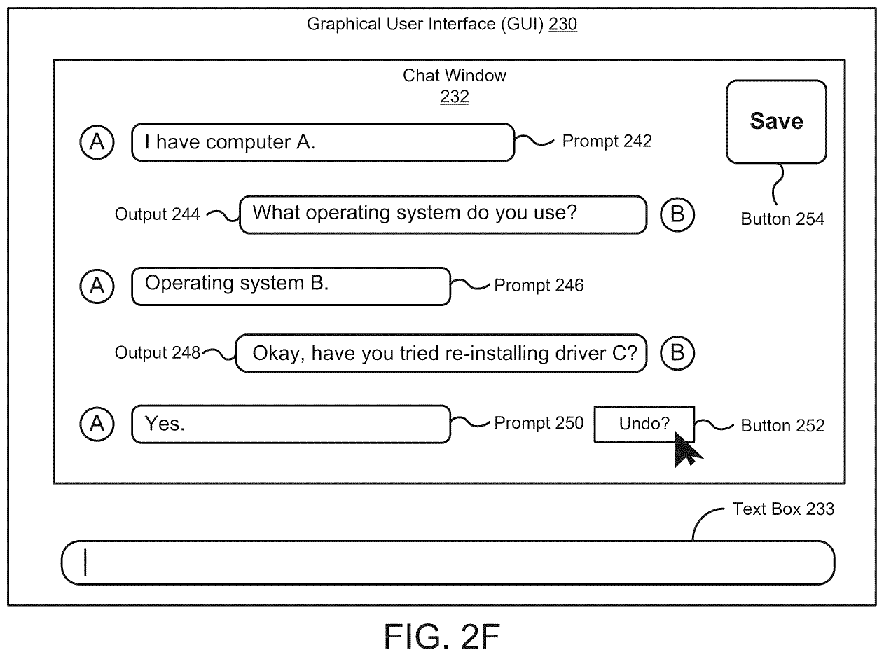

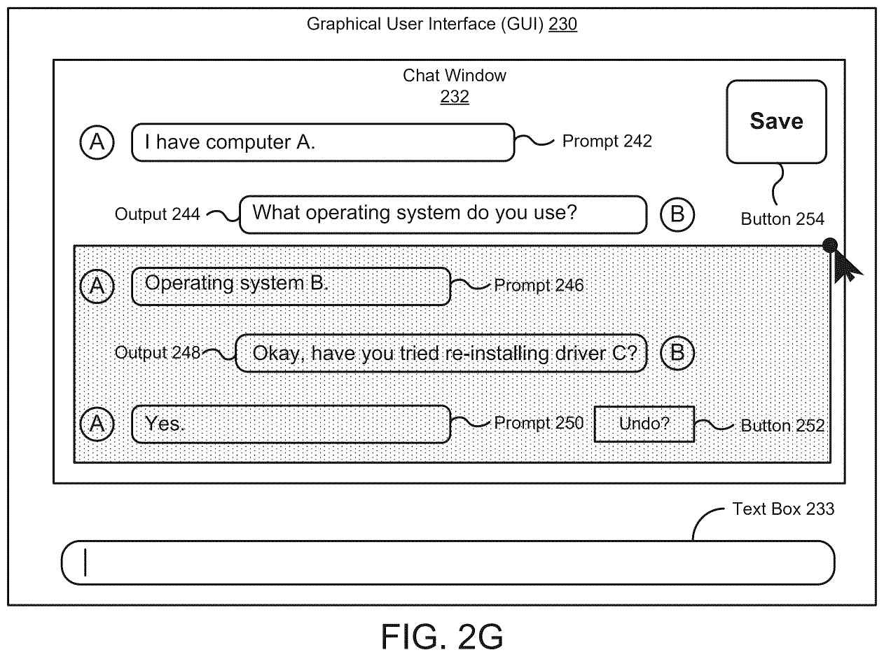

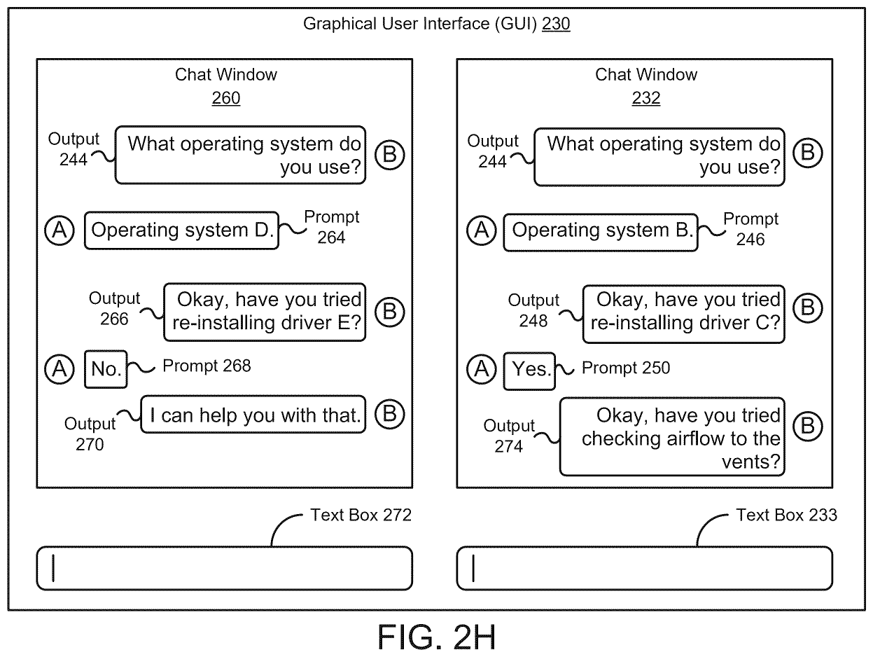

Any number of snapshots may be generated throughout a generative AI session. Snapshots may be generated automatically at various time intervals, may be generated based on selection of an interactive element on a GUI by a downstream consumer (e.g., a “save” button). Refer to FIG. 2A for details regarding obtaining the second generative AI session using a snapshot. Refer to FIGS. 2F-2G for an example of a GUI with a “save” button and a description of how the save button may be used to generate a snapshot of the generative AI model's internal state.

Performing the un-inferencing process may include: (i) obtaining information elements corresponding to information content that is to be removed from an internal state of the first instance of the generative AI model (e.g., the information content that is to be removed may include any information content included in the first generative AI session following the earlier point in the first generative AI session), (ii) obtaining attention strengths for the first instance of the generative AI model corresponding to each of the information elements, (iii) generating, using the attention strengths, un-inferencing weights for the information elements, (iv) performing, using the un-inferencing weights, an un-inferencing process for the first instance of the generative AI model to obtain the second instance of the generative AI model, and/or (v) other methods. Refer to FIG. 2B for additional details regarding performing un-inferencing processes.

Thus, embodiments disclosed herein may improve processes of providing outputs generated by generative AI models to downstream consumers of the outputs. By allowing branching of a first generative AI session to obtain a second generative AI session while continuing the first generative AI session, the downstream consumer may continue one or both of the generative AI sessions to determine how different prompts may influence the interaction without beginning a new generative AI session. Consequently, a likelihood of providing desired computer-implemented services while conserving time resources may be increased.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from clients, from owners of downstream consumer 106A, from employees of a company that owns downstream consumer 106A) to data processing system 100A as part of the subscribed services.

As part of providing the computer-implemented services, data processing systems 100 may: (i) obtain prompts for generative AI models (e.g., hosted and/or operated by data processing systems 100), (ii) feed the prompts into a generative AI model to obtain outputs, and (iii) provide the outputs to downstream consumers as part of providing computer-implemented services to the downstream consumers.

Data processing systems 100 may provide chat session services to downstream consumers 106. For example, one or more of downstream consumers 106 may host AI agents that manage chat sessions with users (e.g., downstream consumers). A record of the chat sessions may be displayed, via the GUI, on a user's device (e.g., one or more of downstream consumers 106).

As part of providing the computer-implemented services, data processing systems 100 may also: (i) obtain a request (e.g., from a downstream consumer) to generate one or more additional generative AI sessions based on a portion of the first generative AI session while continuing the first generative AI session, (ii) reverting, based on the request, a copy of the first generative AI session to an earlier point in the first generative AI session to obtain a second generative AI session and a second instance of the generative AI model, and/or (iii) perform other actions. Additional instances of the generative AI model may be obtained if additional generative AI sessions are requested (e.g., a third instance of the generative AI model may be obtained for a third generative AI session). Refer to FIGS. 2A-2B for additional details regarding reverting the copy of the first generative AI session to the earlier point in the first generative AI session.

Data processing systems 100 may, therefore, participate in the additional generative AI sessions. As part of participating in the second generative AI session, for example, data processing systems 100 may: (i) obtain a first prompt (e.g., from a downstream consumer) for the second generative AI session, the first prompt not being part of the first generative AI session, (ii) obtain, using the second instance of the generative AI model and the first prompt, a first output, and (iii) provide computer-implemented services using at least the first output.

Data processing systems 100 may also continue to participate in the first generative AI session. To do so, data processing systems 100 may: (i) obtain a second prompt (e.g., from a downstream consumer) for the first generative AI session, the second prompt not being part of the second generative AI session, (ii) obtain, using the first instance of the generative AI model and the second prompt, a second output, and (iii) provide computer-implemented services using at least the second output.

Refer to FIGS. 2C-2D for additional details regarding generating the first output and the second output.

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs as part of receiving the computer-implemented services.

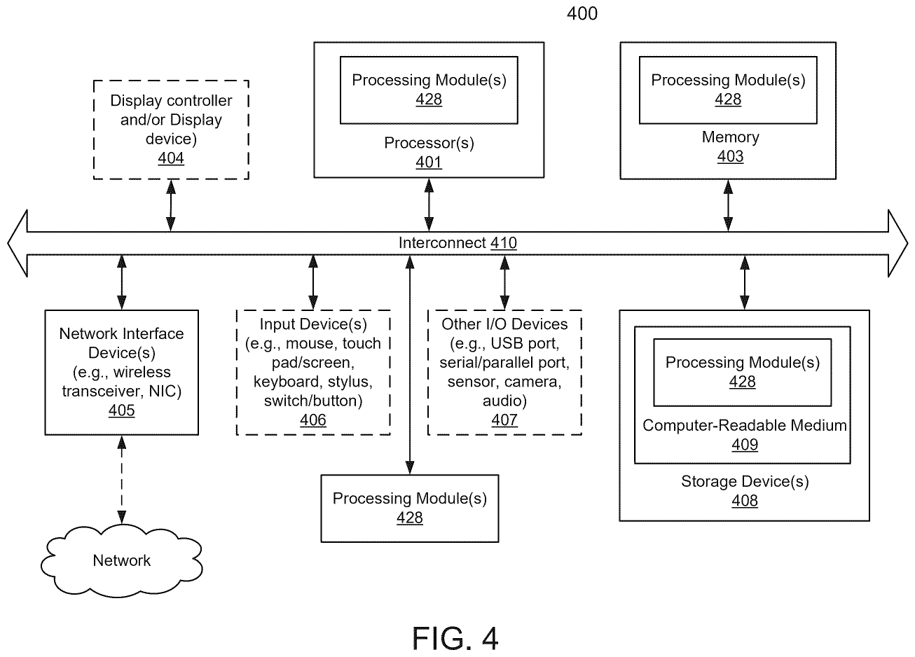

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

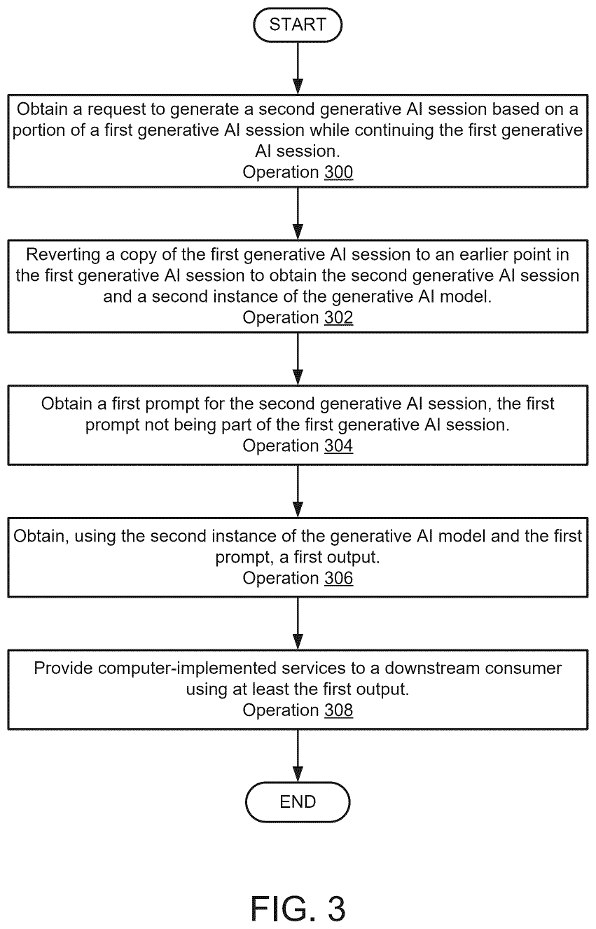

While providing their functionality, any of data processing systems 100, AI model manager 102, and/or downstream consumers 106 may provide all or a portion of the methods shown in FIGS. 2A-3.

To further clarify embodiments disclosed herein, a data flow diagram in accordance with an embodiment is shown in FIG. 2A. In this diagram, flows of data and processing of data are illustrated using different sets of shapes. A first set of shapes (e.g., 200, 206, etc.) is used to represent data structures, a second set of shapes (e.g., 204, 205 etc.) is used to represent processes performed using and/or that generate data, a third set of shapes (e.g., 202, 210) is used to represent generative AI models, and/or other types of models, and a fourth set of shapes (e.g., 203) is used to represent large-scale data structures such as databases.

Turning to FIG. 2A, a first data flow diagram in accordance with an embodiment is shown. The first data flow diagram may illustrate data used in and data processing performed in obtaining a second instance of a generative AI model based on a snapshot of a first instance of the generative AI model.

As part of providing the computer-implemented services, a downstream consumer (e.g., 106A) may initiate a first generative AI session (e.g., a first chat session). During the first chat session, the downstream consumer may provide prompts and an AI agent may provide responses (e.g., outputs generated by a first instance of a generative AI model based on the prompts).

Request 200 may be obtained from the downstream consumer and may include an indication that at least a second generative AI session is to be generated based on a portion of the first generative AI session while continuing the first generative AI session. Request 200 may also indicate an earlier point in the first generative AI session. The earlier point may be used as a branching point for generation of the second generative AI session.

For example, a downstream consumer may desire to see how outputs may change if a most recent prompt had not been provided. Therefore, the downstream consumer may indicate, as part of request 200, a point in the first generative AI session prior to the most recent prompt. To do so, the downstream consumer may: (i) enter a command in a text box of a graphical user interface (GUI) on which the first generative AI session is displayed, (ii) select a button on the GUI, highlight a portion of a chat history of the first generative AI session displayed on the GUI, and/or may perform other actions.

Therefore, the earlier point in the first generative AI session may be the point prior to the most recent prompt. The second generative AI session may include all of the chat history of the first generative AI session except for the information content of the most recent prompt. Any outputs generated based on the most recent prompt may also be excluded from the second generative AI session. The earlier point in the first generative AI session may be any other point in the first generative AI session without departing from embodiments disclosed herein.

To service request 200, generative AI model reversion process 204 may be performed. During generative AI model reversion process 204, first instance of generative AI model 202, request 200, and snapshot database 203 may be used to obtain second instance of generative AI model 210.

First instance of generative AI model 202 may be an LLM (e.g., a neural network inference model) trained to generate language, understand language, and/or otherwise process requests related to languages. First instance of generative AI model 202 may have been previously trained using training data and any training process (e.g., a global optimization process using gradient descent), the training data indicating goals for outputs generated by first instance of generative AI model 202 (e.g., outputs). Parameters of first instance of generative AI model 202 may be selected using an optimization process (e.g., an objective function may be defined in terms of the training data and outputs generated by first instance of generative AI model 202, and a global optimization method such as gradient descent may be used to identify parameters that most faithfully reproduce the trends in the training data). Once the parameters of first instance of generative AI model 202 are set, then first instance of generative AI model 202 may be used to generate outputs (e.g., responses) based on input data (e.g., prompts). First instance of generative AI model 202 may be trained using other methods without departing from embodiments disclosed herein.

Snapshot database 203 may include any number of snapshots of any number of generative AI models. Each snapshot for a generative AI model may be generated at a different point during a generative AI session. For example, any number of snapshots may be generated during the first generative AI session. Snapshots may be generated automatically at regular intervals (e.g., once per minute, after each addition to the generative AI session). The regular intervals may be based on feedback from the downstream consumer, may be based on a policy (e.g., from a subject matter expert (SME), from the downstream consumer, from another entity). In addition, snapshots may be generated manually at any time during the generative AI session. Snapshots may be manually generated, for example, via selection of a button on a GUI, via entering a command into a chat box on a GUI, and/or via other methods.

Each snapshot may include: (i) a generative AI session chat history (e.g., prompts and outputs) up to a point of generation of the snapshot, (ii) a memory of the generative AI session based on the generative AI session chat history (e.g., attention values assigned to portions of the prompts and portions of the outputs), and/or (iii) other information. Each snapshot may be stored in snapshot database 203 and/or in other storage locations.

Snapshot database 203 may be organized via any method so that snapshots may be retrieved as needed to service requests (e.g., request 200) to revert a generative AI model to a prior instance of the generative AI model. Entries in snapshot database 203 may include identifiers for generative AI models, timestamps for generation of the snapshots, metadata associated with the generative AI chat session, and/or other information usable to retrieve a desired snapshot from snapshot database 203.

For example, during generative AI model reversion process 204, an identifier for first instance of generative AI model 202 and an earlier point in the first generative AI session (e.g., indicated by request 200) may be used to request and/or retrieve a generative AI model snapshot from snapshot database 203. The generative AI model snapshot retrieved from snapshot database 203 may be used as second instance of generative AI model 210 and the second generative AI session may begin using second instance of generative AI model 210 to operate on any future prompts provided as part of the second generative AI session.

Beginning the second generative AI session may include populating a GUI with a new chat window showing a chat history for the second generative AI session and a second text box usable to provide prompts as part of the second generative AI session. Therefore, at a time of generation of the second generative AI session, the second generative AI session may begin at a start of the first generative AI session and may end at the earlier point in the first generative AI session (e.g., when the snapshot was generated). Refer to FIG. 2H for an example of a GUI displaying two generative AI sessions.

Turning to FIG. 2B, a second data flow diagram in accordance with an embodiment is shown. The second data flow diagram may illustrate data used in and data processing performed in performing an un-inferencing process to obtain a second instance of a generative AI model based on a portion of a first instance of the generative AI model. The processes shown in FIG. 2B may be another method to obtain second instance of generative AI model 210 described in FIG. 2A.

To perform the un-inferencing process, generative AI model reversion process 205 may be performed. During generative AI model reversion process 205, request 200, first instance of generative AI model 202, and first generative AI session history 206 may be used to obtain second instance of generative AI model 210. Refer to the description of FIG. 2A for a description of request 200.

First generative AI session history 206 may include any number of prompts (e.g., prompt A, prompt B) and any number of outputs based on the prompts (e.g., output A, output B). Prompt A, for example, may have been provided by the downstream consumer during the chat session and may have been used to generate output A (e.g., by first instance of generative AI model 202). Output B may be generated by feeding prompt A, output A, and prompt B into first instance of generative AI model 202. An AI agent (e.g., a software program) may retrieve output B and may populate a chat window on the GUI using output B as part of the chat session.

During generative AI model reversion process 205, an un-inferencing process may be performed to reduce an impact of a portion of information content of first generative AI session history 206 on the second generative AI session. To do so, information elements corresponding to the information content that is to be removed from an internal state of first instance of generative AI model 202 may be obtained. The information elements may be obtained based on the earlier point in the first generative AI session indicated by request 200.

A memory of first instance of generative AI model 202 may be used to obtain attention strengths for first instance of generative AI model 202 corresponding to each of the information elements. The attention strengths may be based on frequencies of occurrence of the information elements in first generative AI session history 206. For example, a first information element may occur more frequently in first generative AI session history 206 than a second information element and, therefore, may have a higher attention strength than the second information element.

Un-inferencing weights may be generated for each of the information elements using at least the attention strengths. The un-inferencing weights may be generated in any manner and may be used to reduce an impact of the information elements in a manner that scales with frequencies of occurrence for the information elements.

For example, consider a scenario in which four information elements are present in first generative AI session history 206. A first information element of the four information elements may have a frequency of occurrence of one. A second information element of the four information elements may have a frequency of occurrence of 5. A third information element of the four information elements may have a frequency of occurrence of 2. A fourth information element of the four information elements may have a frequency of occurrence of 2. The frequencies of occurrence may be higher, for example, if a particular information element is referenced, used as context, and/or otherwise re-stated.

Continuing with the above example, un-inferencing weights may be obtained for each of the four information elements. The un-inferencing weights may be represented as percentages. The first information element may have an un-inferencing weight of 0.1, the second information element may have an un-inferencing weight of 0.5, the third information element may have an un-inferencing weight of 0.2 and the fourth information element may also have an un-inferencing weight of 0.2.

While described in this example as using numbers to represent attention strengths and percentages to represent un-inferencing weights, attention strengths and un-inferencing weights may be represented in other ways without departing from embodiments disclosed herein.

The un-inferencing weights may be used to generate second instance of generative AI model 210. In a first example, the un-inferencing weights may be used to negate embeddings corresponding to the information elements (e.g., embeddings corresponding to the information elements may be multiplied by their corresponding un-inferencing weights and by negative one to reverse a sign of the embeddings) thereby updating a memory of first instance of generative AI model 202 to obtain second instance of generative AI model 210.

In a second example, a negation layer may be added to an input layer of first instance of generative AI model 202 to obtain second instance of generative AI model 210. The negation layer may be configured to multiply each information element (e.g., an attention value for the information element) by a corresponding un-inferencing weight of the un-inferencing weights to obtain an un-inferenced value (e.g., an un-inferenced attention value) for the information element. The un-inferenced value may continue to a next layer of second instance of generative AI model 210. By doing so, the un-inferenced value may have less impact on future outputs generated by second instance of generative AI model 210 than the information element (e.g., if the information element was processed without the negation layer).

In a third example, the negation layer may be added prior to an attention module of first instance of generative AI model 202 to obtain second instance of generative AI model 210.

In a fourth example, the negation layer may be added to a hidden layer of the attention module to obtain second instance of generative AI model 210.

Turning to FIG. 2C, a third data flow diagram in accordance with an embodiment is shown. The third data flow diagram may illustrate data used in and data processing performed in generating an output using the first instance of the generative AI model as part of the first generative AI session.

To generate the output, output generation process 212 may be performed using prompt C 208, first instance of generative AI model 202, and first generative AI session history 206. Prompt C 208 may be a new prompt that is not included in the second generative AI session (e.g., second instance of generative AI model 210 may not operate on prompt C 208). Prompt C 208 may have been provided by the downstream consumer (e.g., via a GUI).

During output generation process 212, prompt C 208 and first generative AI session history 206 may be ingested by first instance of generative AI model 202 to obtain output C (shown as part of updated first generative AI session history 214). Output C may be based on prompt C 208 and may use first generative AI session history 206 as context to generate output C.

During output generation process 212, prompt C 208 and output C may be added to first generative AI session history 206 to generate updated first generative AI session history 214.

Turning to FIG. 2D, a fourth data flow diagram in accordance with an embodiment is shown. The fourth data flow diagram may illustrate data used in and data processing performed in generating an output using the second instance of the generative AI model as part of the second generative AI session. The processes shown in FIG. 2D may occur synchronously or asynchronously with the processes shown in FIG. 2C (e.g., both the first generative AI session and the second generative AI session may be active).

To generate the output, output generation process 222 may be performed using prompt D 224, second instance of generative AI model 210, and second generative AI session history 220. Prompt D 224 may be a new prompt that is not included in the first generative AI session (e.g., first instance of generative AI model 202 may not operate on prompt D 224). Prompt D 224 may have been provided by the downstream consumer (e.g., via a GUI).

Second generative AI session history 220 may include a portion of first generative AI session history 206 (e.g., prompt A and output A). However, second generative AI session history 220 may not include prompt B and output B. Therefore, the first generative AI session may have been reverted to a point prior to prompt B to generate the second generative AI session.

During output generation process 222, prompt D 224 and second generative AI session history 220 may be ingested by second instance of generative AI model 210 to obtain output D (shown as part of updated second generative AI session history 226). Output D may be based on prompt D 224 and may use second generative AI session history 220 as context to generate output D.

During output generation process 222, prompt D 224 and output D may be added to second generative AI session history 220 to generate updated second generative AI session history 226.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and fourth set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, by implementing the data flows shown in FIGS. 2A-2D, a system in accordance with embodiments disclosed herein may be used to branch a generative AI session to obtain multiple generative AI sessions that may be simultaneously active. By doing so, a downstream consumer may provide different prompts to the multiple generative AI sessions to see how one or more different prompts may impact the interactions without starting a new generative AI session. Consequently, a reliability and/or usefulness of outputs may be increased for the downstream consumer.

Turning to FIG. 2E, an example graphical user interface (GUI) is shown. GUI 230 may display at least chat window 232 and text box 233. GUI 230 may be accessible by downstream consumers (e.g., via a website) and may include any number of pop-up interfaces, chat windows, buttons, graphics, and/or other elements through which information may be displayed to a viewer (e.g., a downstream consumer) and/or through which the viewer may interact. Other entities (e.g., an AI agent managing a chat service, a data processing system hosting the AI agent and/or any number of generative AI models) may populate GUI 230 with data intended to be displayed to the downstream consumer.

A downstream consumer may initiate a chat session with an AI agent (e.g., a computer program such as a chatbot) and chat window 232 and text box 233 may be displayed on GUI 230 to the downstream consumer for a duration of the chat session.

A customer may open chat window 232 and may enter prompt 234 into text box 233. Prompt 234 may include the following text: “My computer is not working. I need help.” Prompt 234 is shown next to a circle with the letter “A” inside the circle to indicate input from a first entity (e.g., the downstream consumer).

Prompt 234 may be used as ingest for a first instance of a generative AI model (e.g., first instance of generative AI model 202 described in FIG. 2A) and output 236 may be obtained as output from the first instance of the generative AI model. The first instance of the generative AI model (e.g., and/or an AI agent participating in the chat session) may provide output 236 as a response to prompt 234. Output 236 may include the following text: “Sure, I can help you with that! What seems to be the problem with your computer?” Output 236 is shown next to a circle with the letter “B” inside the circle to indicate input from a second entity (e.g., the first instance of the generative AI model by way of the AI agent).

The downstream consumer may provide prompt 238 in response to output 236 and to continue the first generative AI session (e.g., the first chat session). Prompt 238 may include the text: “My computer is overheating.” The generative AI model may take into account (e.g., may use as input) at least prompt 234, output 236, and prompt 238 to generate output 240. Therefore, each output generated by the first instance of the generative AI model may be generated in the context of the entire interaction.

Output 240 may include the text: “What kind of computer do you have?” The first instance of the generative AI model may be configured to prompt the downstream consumer to provide specific types of information based on the prompts provided by the downstream consumer.

The downstream consumer may provide prompt 242 in response. Prompt 242 may include the text: “I have computer A.”

The first instance of the generative AI model may utilize the entire chat history to generate output 244 with the text: “What operating system do you use?” In response to output 244, the downstream consumer may provide prompt 246 with the text: “Operating system B.”

The first instance of the generative AI model may utilize the entire chat history to generate output 248 with the text: “Okay, have you tried re-installing driver C?” The downstream consumer may provide prompt 250 in response to output 248, prompt 250 including the text: “Yes.”

Turning to FIG. 2F, a zoomed-in portion of the first generative AI session shown in FIG. 2E is shown. While only prompt 242, output 244, prompt 246, output 248, and prompt 250 are shown in FIG. 2F, it may be appreciated that the first generative AI session shown in FIG. 2F is the same first generative AI session shown in FIG. 2E. The zoomed-in portion of the first generative AI session is shown in FIG. 2F for clarity.

The downstream consumer may decide that a copy of the first generative AI session is to be reverted to an earlier point in the first generative AI session history to generate a second generative AI session (e.g., to branch the first generative AI session into two generative AI sessions that both may continue). For example, the downstream consumer may realize that they accidentally provided inaccurate information in prompt 246 (e.g., they may not use operating system B). The downstream consumer may wish to revert the copy of the first generative AI session to an earlier point in the first generative AI session history for other reasons without departing from embodiments disclosed herein.

To generate the second generative AI session based on a portion of the first generative AI session, the downstream consumer may select an interactive element of GUI 230. The interactive element may be button 252 and button 252 may include the text “Undo?” Button 252 may include other text, may have other shapes, may be positioned in other locations on GUI 230, and/or may otherwise be any other kind of button without departing from embodiments disclosed herein.

In FIG. 2F, button 252 may appear next to a most recent element (e.g., prompt or output) in chat window 232. For example, the downstream consumer may hover the cursor over prompt 250 and button 252 may appear. Button 252 may appear permanently next to the most recent element, may appear following other interactions (e.g., entering a command into text box 233, selecting other interactive elements on GUI 230) without departing from embodiments disclosed herein.

GUI 230 may also include button 254. Button 254 may be a second interactive element of GUI 230 and, if clicked, button 254 may generate a snapshot of the generative AI model and may save the snapshot in a snapshot database. Button 254 may be any other type of button without departing from embodiments disclosed herein. Snapshots may be generated via other methods (e.g., entering a command) without departing from embodiments disclosed herein. Refer to FIG. 2A for additional details regarding snapshots.

Turning to FIG. 2G, the downstream consumer may provide first user input by clicking on button 252. Clicking on button 252 may initiate a highlighting process by which the downstream consumer may provide second user input (e.g., may indicate an earlier point in the chat history to which the chat session history is to be reverted.

In FIG. 2G, the earlier point in the chat session history may be prior to prompt 246 (e.g., prompt 246, output 248, and prompt 250 may be highlighted). The downstream consumer may modify the earlier point in the chat session by selecting the filled in circle in the top right-hand corner of the highlighted section and dragging the circle up or down to modify an extent of the selection. The earlier point in the chat history may be selected via other interactions with GUI 230 without departing from embodiments disclosed herein.

Turning to FIG. 2H, a second generative AI session (e.g., shown as chat window 260 and text box 272) may be added to GUI 230 based on the downstream consumer's feedback as shown in FIG. 2G. The first generative AI session (e.g., chat window 232 and text box 233) may appear in a separate window of GUI 230 than the second generative AI session (e.g., chat window 260 and text box 272).

The downstream consumer, therefore, may provide a first prompt (e.g., prompt 264) using text box 272 to see how the interaction may have progressed if prompt 246 had not been entered into the first generative AI session. Prompt 264 may include the text: “Operating system D.”

Chat window 260 may include the second generative AI session history (e.g., including prompt 264, output 244 and the components of the first generative AI session history before output 244 shown in FIG. 2E).

Output 266 may be generated using prompt 264 and the earlier portions of the second generative AI session history. Output 266 may include the text: “Okay, have you tried re-installing driver E?” Therefore, providing prompt 264 instead of prompt 246 (provided as part of the first generative AI session as shown in chat window 232), may have caused the AI agent to recommend a different action.

As shown in chat window 260, the downstream consumer may provide prompt 268 in response to output 266. Prompt 268 may include the text: “No.” The second instance of the generative AI model may use prompt 268, output 266, prompt 264, output 244, and all previous portions of the second generative AI session history to generate output 270. Output 270 may include the text: “I can help you with that.”

The downstream consumer may also input additional prompts to text box 233 to see how the first generative AI session may have progressed. Consequently, the downstream consumer may use text box 233 to enter prompt 250 with the text: “Yes.”

The first instance of the generative AI model may use prompt 250, output 248, prompt 246, output 244, and all earlier portions of the first generative AI session history to generate output 274. Output 274 may include the text: “Okay, have you tried checking airflow to the vents?”

Thus, the downstream consumer may continue both the first generative AI session and the second generative AI session via GUI 230. Additional generative AI sessions may be generated and continued without departing from embodiments disclosed herein.

FIGS. 2E-2H show an example GUI and examples of generative AI sessions between a downstream consumer and a backend system (e.g., an entity that hosts and/or operates generative AI models). It may be appreciated that the GUI may include other elements and information may be provided by the downstream consumer to the backend system via other methods without departing from embodiments disclosed herein.

As discussed above, the components of FIG. 1 may perform various methods to manage a data processing system. FIG. 3 illustrates methods that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing computer-implemented services using generative AI models in accordance with an embodiment is shown. The method may be performed, for example, by any of the components of the system of FIG. 1, and/or other components not shown therein.

At operation 300, a request may be obtained from a downstream consumer to generate a second generative AI session based on a portion of a first generative AI session while continuing the first generative AI session. Obtaining the request may include: (i) obtaining first user input indicating that the downstream consumer has selected the interactive element on the GUI, (ii) obtaining second user input indicating information content that is desired to be removed from the generative AI session history, and/or (iii) other methods.

Obtaining the first user input may include: (i) receiving feedback, via the GUI, indicating that the downstream consumer has clicked on an interactive element of the GUI (e.g., an undo button), (ii) reading the first user input from storage, (iii) receiving the first user input from another entity, and/or (iv) other methods.

Obtaining the second user input may include methods similar to those described with respect to obtaining the first user input. For example, obtaining the second user input may include receiving feedback, via the GUI, that the downstream consumer has: (i) highlighted a portion of the generative AI session history, (ii) typed in a command and/or other text to indicate the earlier point in time of the generative AI session history, and/or (iii) otherwise selected the information content desired to be removed.

Prior to making the first identification, a prompt of the prompts may be obtained from the downstream consumer and via the GUI. Obtaining the prompt may include: (i) receiving a notification that the downstream consumer has typed in the prompt to a text box (e.g., an interactive element that allows the downstream consumer to type and enter text using a human interface device such as a keyboard) of the GUI, (ii) reading the prompt from storage, (iii) receiving the prompt from another entity, and/or (iv) other methods.

An output of the outputs may also be obtained prior to making the first identification using the prompt and the generative AI model. Obtaining the output may include: (i) feeding at least the prompt into the generative AI model as ingest and obtaining, as an output from an output layer of the generative AI model, the output, (ii) reading the output from storage, (iii) receiving the output from another entity, and/or (iv) other methods.

The GUI may be populated using at least the prompt, the output, and the interactive element prior to making the first identification. Populating the GUI may include: (i) uploading the prompt and the output to the GUI using an application programming interface (API), a software program, and/or other means of displaying data to the downstream consumer via the GUI (e.g., via a chat interface of the GUI), (ii) providing the output and the prompt to another entity responsible for uploading the prompt and the output to the GUI, (iii) generating a portion of code that defines properties of the interactive element (e.g., visual aspects such as size, shape and color, text included in the interactive element, actions linked to activation of the interactive element), (iv) adding the portion of code to a codebase for the GUI, (v) providing the portion of code to another entity, (vi) providing the properties of the interactive element and instructions for generating the portion of the code to another entity, and/or (vii) other methods.

At operation 302, a copy of the first generative AI session may be reverted to an earlier point in the first generative AI session to obtain the second generative AI session and a second instance of the generative AI model.

Reverting the copy of the first generative AI session may include: (i) obtaining a snapshot of the first instance of the generative AI model, the snapshot being generated at the earlier point in the first generative AI session, (ii) using the snapshot as the second instance of the generative AI model, and/or (iii) other methods.

Obtaining the snapshot may include: (i) reading the snapshot from storage (e.g., a snapshot database), (ii) performing a lookup process using a snapshot database lookup table and identifying information (e.g., an identifier for the generative AI model, information related to the earlier point in the first generative AI session specified by the request) as a key for the snapshot database lookup table to retrieve the snapshot from the snapshot database, (iii) receiving the snapshot from another entity, and/or (iv) other methods.

Using the snapshot as the second instance of the generative AI model may include: (i) storing a copy of the snapshot in storage, the copy being labeled as the second instance of the generative AI model, (ii) connecting the second generative AI session to the snapshot (e.g., generating instructions indicating that prompts provided as part of the second generative AI session are to be routed to the snapshot for processing), (iii) notifying another entity that the snapshot is to be used as the second instance of the generative AI model, (iv) populating a GUI with a second window, the second window including the second generative AI session history, and/or (v) other methods.

The snapshot may have been generated, for example, at the earlier point in time specified by the request (e.g., prior to obtaining the request). Generating the snapshot at the earlier point in the first generative AI session may include: (i) adding elements of the first generative AI session history (e.g., prompts, outputs) to a data structure, (ii) adding information regarding a memory of the first instance of the generative AI model at the point in time of generation of the snapshot (e.g., attention values, embeddings) to the data structure, (iii) labeling the data structure using information such as an identifier for the generative AI model, a timestamp for generation of the snapshot, metadata indicating the point in the generative AI session when the snapshot was generated, and/or (iv) other methods.

After generating the snapshot, the snapshot may be stored in a snapshot database. Storing the snapshot in the snapshot database may include: (i) identifying a location in the snapshot database where the snapshot is to be stored, (ii) performing a storage process using the data structure to generate an entry in the storage database, (iii) providing the snapshot to another entity responsible for storing the snapshot in the snapshot database, and/or (iv) other methods.

Reverting the copy of the generative AI session may also include: (i) obtaining information elements corresponding to information content that is to be removed from an internal state of the first instance of the generative AI model, (ii) obtaining attention strengths for the first instance of the generative AI model corresponding to each of the information elements, (iii) generating, using the attention strengths, un-inferencing weights for the information elements, (iv) performing, using the un-inferencing weights, an un-inferencing process for the first instance of the generative AI model to obtain the second instance of the generative AI model, and/or (v) other methods.

Obtaining the information elements may include: (i) reading the information elements from storage, (ii) generating the information elements using natural language processing, object recognition, and/or other algorithms to identify portions of information content (e.g., words, tokens, embeddings, phrases), (iii) receiving the information elements from another entity, and/or (iv) other methods.

Obtaining the attention strengths may include: (i) reading the attention strengths from storage, (ii) receiving the attention strengths from another entity, (iii) generating the attention strengths using the information elements and a memory of the first instance of the generative AI model, and/or (iv) other methods. Generating the attention strengths may include: (i) obtaining frequencies of occurrence (e.g., implicit occurrences such as references, hints and explicit occurrences) for each information element of the information elements corresponding to the information content that is to be removed from the internal state of the first instance of the generative AI model (e.g., searching the first generative AI session history for instances of the information elements and/or instances of use of the information elements as context), (ii) assigning the attention strengths to the information elements based on the frequencies of occurrence, and/or (iii) other methods.

Generating the un-inferencing weights may include: (i) executing an algorithm (e.g., one or more mathematical formulas) on each of the attention strengths to obtain the un-inferencing weights (e.g., values for the information elements normalized relative to each other to represent the relative attention strengths), (ii) providing the attention strengths to another entity responsible for calculating the un-inferencing weights, and/or (iii) other methods.

Performing the un-inferencing process may include at least one action selected from a list of actions consisting of: (i) negating, using the un-inferencing weights, embeddings corresponding to the information elements to obtain the second instance of the generative AI model, (ii) adding, based on the request and using the un-inferencing weights, a negation layer to an input layer of the first instance of the generative AI model to obtain the second instance of the generative AI model, (iii) adding, based on the request and using the un-inferencing weights, the negation layer prior to an attention module of the first instance of the generative AI model to obtain the second instance of the generative AI model, (iv) adding, based on the request and using the un-inferencing weights, the negation layer to a hidden layer of the attention module to obtain the second instance of the generative AI model, and (v) removing (e.g., deleting) tokens that correspond to the information elements from a memory (e.g., attention) of the first instance of the generative AI model.

Negating the embeddings may include: (i) obtaining the embeddings corresponding to the information content (e.g., reading the embeddings from storage, obtaining the embeddings from another entity), (ii) multiplying each embedding by its corresponding un-inferencing weight and by negative one to flip a sign of the embedding, and/or (iii) other methods. Doing so may update a memory of the first instance of the generative AI model to obtain a memory of the second instance of the generative AI model.

Adding the negation layer to the generative AI model may include: (i) identifying elements (e.g., neurons) of an input layer of the generative AI model that consume the information content, (ii) performing an operation to modify a latent representation of the information content prior to or following ingestion by the neurons of the input layer, and/or (iii) other methods. Modifying the latent representation may include changing attention values of the input (e.g., multiplying the attention values by negative one and the corresponding un-inferencing weights). By doing so, the information content may be processed in a negated form (e.g., by the input layer, by a layer of neurons after the input layer).

Adding the negation layer (e.g., a layer that performs the modification of the information content) that feeds into the attention module may include methods similar to those described with respect to adding the negation layer to the input layer. However, the negation layer may be added to elements of the generative AI model that are located prior to an attention module of the generative AI model rather than in the input layer. Therefore, partially processed input data may pass through the negation layer prior to entering the attention module (e.g., attention layer) and/or after exiting the attention module.

Adding the negation layer to the hidden layer of the attention module may include methods similar to those described with respect to adding the negation layer to the input layer. However, the negation layer may be added within a hidden layer of the attention module rather than to the input layer. Therefore, partially processed input data may enter the attention module, pass through the negation layer at some point within the attention module, and may exit the attention module having passed through the negation layer.

At operation 304, a first prompt for the second generative AI session may be obtained. The first prompt may not be a part of the first generative AI session. Obtaining the first prompt may include: (i) reading the first prompt from storage, (ii) receiving the first prompt from another entity, (iii) receiving the first prompt via a GUI (e.g., via the downstream consumer typing the first prompt into a text box of the GUI and submitting the entered text using one or more interaction elements of the GUI), and/or (iv) other methods.

At operation 306, a first output may be obtained using the second instance of the generative AI model and the first prompt. Obtaining the first output may include: (i) reading the first output from storage, (ii) feeding the first prompt and the second AI session history into the second instance of the generative AI model to obtain the first output from an output layer of the second instance of the generative AI model, (iii) providing at least the first prompt to another entity responsible for operating the second instance of the generative AI model, and/or (iv) other methods.

At operation 308, computer-implemented services may be provided to a downstream consumer using at least the first output. Providing the computer-implemented services to the downstream consumer may include: (i) populating the GUI with at least the first output (e.g., as part of the second generative AI session), (ii) making decisions based on at least the first output, (iii) providing the first output to another entity, (iv) selecting one or more actions based on the first output and performing the one or more actions to update operation of a system, and/or (v) other methods.

The method may end following operation 308.

The first generative AI session may also continue (e.g., additional prompts may be provided as part of the first generative AI session, outputs may be generated by the first instance of the generative AI model based on the first generative AI session history and the additional prompts).

For example, a second prompt for the first generative AI session may be obtained from the downstream consumer. Obtaining the second prompt may include methods similar to those described in operation 304 with respect to obtaining the first prompt. The second generative AI session and the second instance of the generative AI model may not operate on the second prompt (e.g., the second prompt may not be used as part of the second generative AI session).

A second output may be obtained using the first instance of the generative AI model and the second prompt using methods similar to those described with respect to obtaining the first output in operation 306 (e.g., using the second prompt in place of the first prompt and the first instance of the generative AI model in place of the second instance of the generative AI model).

The computer-implemented services may also be provided using the second output. Providing the computer-implemented services using the second output may include methods similar to those described in operation 308 with respect to providing the computer-implemented services using at least the first output.

Thus, as illustrated above, embodiments disclosed herein may provide systems and methods usable to provide computer-implemented services using generative AI models. By generating a second generative AI session based on a portion of the first generative AI session while continuing the first generative AI session, a likelihood of future outputs generated during the chat session meeting needs of the downstream consumer may be increased.

Any of the components illustrated in FIGS. 1-2H may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
obtaining, from a downstream consumer, a request to generate a second generative AI session based on a portion of a first generative AI session while continuing the first generative AI session, the first generative AI session comprising prompts provided by the downstream consumer and outputs generated by a first instance of a generative AI model of the generative AI models based on the prompts;
reverting, based on the request, a copy of the first generative AI session to an earlier point in the first generative AI session to obtain the second generative AI session and a second instance of the generative AI model;
obtaining a first prompt from the downstream consumer for the second generative AI session, the first prompt not being part of the first generative AI session;
obtaining, using the second instance of the generative AI model and the first prompt, a first output; and
providing computer-implemented services to the downstream consumer using at least the first output.

2. The method of claim 1, further comprising:
obtaining, from the downstream consumer, a second prompt for the first generative AI session; and
obtaining, using the first instance of the generative AI model and the second prompt, a second output,
wherein the computer-implemented services are also provided using the second output.

3. The method of claim 2, wherein the second generative AI session and the second instance of the generative AI model do not operate on the second prompt.

4. The method of claim 1, wherein the second generative AI session begins at a start of the first generative AI session and ends at the earlier point in the first generative AI session when the copy of the first generative AI session is reverted to the earlier point in the first generative AI session.

5. The method of claim 1, wherein the first generative AI session and the second generative AI session are displayed to the downstream consumer via at least one graphical user interface (GUI).

6. The method of claim 1, wherein reverting the copy of the first generative AI session to the earlier point in the first generative AI session comprises:
obtaining a snapshot of the first instance of the generative AI model, the snapshot being generated at the earlier point in the first generative AI session; and
using the snapshot as the second instance of the generative AI model.

7. The method of claim 6, wherein the snapshot comprises:
prompts provided by the downstream consumer prior to the earlier point in the first generative AI session;
outputs generated by the first instance of the generative AI model prior to the earlier point in the first generative AI session; and
a memory of the first generative AI session based on the prompts and the outputs, the memory comprising attention values assigned to portions of the prompts and the outputs.

8. The method of claim 6, further comprising:
prior to obtaining the request:
generating the snapshot at the earlier point in the first generative AI session; and
storing the snapshot in a snapshot database.

9. The method of claim 1, wherein reverting the copy of the first generative AI session to the earlier point in the first generative AI session comprises:
obtaining information elements corresponding to information content that is to be removed from an internal state of the first instance of the generative AI model;
obtaining attention strengths for the first instance of the generative AI model corresponding to each of the information elements;
generating, using the attention strengths, un-inferencing weights for the information elements; and
performing, using the un-inferencing weights, an un-inferencing process for the first instance of the generative AI model to obtain the second instance of the generative AI model.

10. The method of claim 9, wherein the second instance of the generative AI model is less impacted by the information elements than the first instance of the generative AI model.

11. The method of claim 9, wherein the attention strengths are based on frequencies of occurrence of the information elements in a generative AI session history for the first generative AI session.

12. The method of claim 9, wherein performing the un-inferencing process comprises at least one action selected from a list of actions consisting of:
negating, using the un-inferencing weights, embeddings corresponding to the information elements to obtain the second instance of the generative AI model;
adding, based on the request and using the un-inferencing weights, a negation layer to an input layer of the first instance of the generative AI model to obtain the second instance of the generative AI model;
adding, based on the request and using the un-inferencing weights, the negation layer prior to an attention module of the first instance of the generative AI model to obtain the second instance of the generative AI model; and
adding, based on the request and using the un-inferencing weights, the negation layer to a hidden layer of the attention module to obtain the second instance of the generative AI model.

13. The method of claim 12, wherein the negation layer multiplies each information element by a corresponding un-inferencing weight of the un-inferencing weights to obtain an un-inferenced value for the information element, the un-inferenced value having less impact on future outputs generated by the second instance of the generative AI model than the information element.

14. The method of claim 1, wherein the generative AI model is a large language model (LLM).

15. A non-transitory machine-readable medium having instructions stored therein, which when executed by a processor, cause the processor to perform operations for providing computer-implemented services using generative artificial intelligence (AI) models, the operations comprising:
obtaining, from a downstream consumer, a request to generate a second generative AI session based on a portion of a first generative AI session while continuing the first generative AI session, the first generative AI session comprising prompts provided by the downstream consumer and outputs generated by a first instance of a generative AI model of the generative AI models based on the prompts;
reverting, based on the request, a copy of the first generative AI session to an earlier point in the first generative AI session to obtain the second generative AI session and a second instance of the generative AI model;
obtaining a first prompt from the downstream consumer for the second generative AI session, the first prompt not being part of the first generative AI session;
obtaining, using the second instance of the generative AI model and the first prompt, a first output; and
providing computer-implemented services to the downstream consumer using at least the first output.

16. The non-transitory machine-readable medium of claim 15, wherein the operations further comprise:
obtaining, from the downstream consumer, a second prompt for the first generative AI session; and
obtaining, using the first instance of the generative AI model and the second prompt, a second output,
wherein the computer-implemented services are also provided using the second output.

17. The non-transitory machine-readable medium of claim 16, wherein the second generative AI session and the second instance of the generative AI model do not operate on the second prompt.

18. A data processing system, comprising:
a processor; and
a memory coupled to the processor to store instructions, which when executed by the processor, cause the processor to perform operations for providing computer-implemented services using generative artificial intelligence (AI) models, the operations comprising:
obtaining, from a downstream consumer, a request to generate a second generative AI session based on a portion of a first generative AI session while continuing the first generative AI session, the first generative AI session comprising prompts provided by the downstream consumer and outputs generated by a first instance of a generative AI model of the generative AI models based on the prompts;
reverting, based on the request, a copy of the first generative AI session to an earlier point in the first generative AI session to obtain the second generative AI session and a second instance of the generative AI model;
obtaining a first prompt from the downstream consumer for the second generative AI session, the first prompt not being part of the first generative AI session;
obtaining, using the second instance of the generative AI model and the first prompt, a first output; and
providing computer-implemented services to the downstream consumer using at least the first output.

19. The data processing system of claim 18, wherein the operations further comprise:
obtaining, from the downstream consumer, a second prompt for the first generative AI session; and
obtaining, using the first instance of the generative AI model and the second prompt, a second output,
wherein the computer-implemented services are also provided using the second output.

20. The data processing system of claim 19, wherein the second generative AI session and the second instance of the generative AI model do not operate on the second prompt.
